(19) United States
(12) Patent Application Publication
(10) Pub. No.: US 2016/0059910 A1
(43) Pub. Date: Mar. 3, 2016

(54) AERODYNAMICALLY EFFICIENT FREIGHT TRUCK AND TRAILER

(71) Applicant: ALIZE DESIGN, LLC, Charlotte, NC (US)

(72) Inventors: HENRI G. DURAND, Charlotte, NC (US); DAVID H. WAFER, MOORESVILLE, NC (US)

(73) Assignee: ALIZE DESIGN, LLC, CHARLOTTE, NC (US)

(21) Appl. No.: 14/838,587

(22) Filed: Aug. 28, 2015

Related U.S. Application Data
(60) Provisional application No. 62/043,108, filed on Aug. 28, 2014.

(51) Int. Cl. B62D 35/00; B62D 35/02

(52) U.S. Cl. CPC B62D 35/001; B62D 35/02

(57) ABSTRACT

Apparatus for improving aerodynamics of a freight tractor-trailer combination, having at least one of the following:
a series of retractable roller-mounted screens connecting the rear of the tractor with the front of a trailer;
a fairing fixed to each side of the trailer near the front of the trailer, and which is adapted to fit about the rear wheels on the tractor when the tractor and trailer are connected, such fairing extending downwardly from the trailer side, and extending rearwardly towards the center of the trailer underside;
a pair of laterally spaced fairings connected to the underside of the trailer about the fore and aft rearmost pairs of wheels, each of said fairings having an aerodynamic rounded forward edge, and a rearward taper to a rear point;
an air deflector positioned at the bottom rear of the trailer, and having a slight upsweep to direct air passing beneath the trailer to a distant centerpoint to the rear of the trailer;
an upper baffle at the top of a rear roll-up door on the trailer positioned to direct air passing over the top of the trailer to a distant centerpoint behind the trailer; and
an aerodynamically improved rearview mirror mounted on the tractor having a wing profile truncated thereon.

### CROSS REFERENCE TO RELATED APPLICATION

This application claims the benefit of U.S. Provisional Application No. 62/043,108, filed Aug. 28, 2014.

### FIELD OF THE INVENTION

The present invention relates to a method and apparatus for the reduction of aerodynamic drag for moving ground vehicles; specifically to an improved device or devices for the reduction of aerodynamic drag, particularly in freight tractors and semi-trailers, which connect to a trailer by a “fifth wheel”.

### BACKGROUND OF THE INVENTION

Reduction of aerodynamic drag in moving ground vehicles, specifically in tractor-trailers for hauling freight (commonly known as Class 8 Tractor Trailer combination), causes improvement in operational performance and an increase in fuel economy of multiple component vehicles by lowering the pressure acting on the front face of the trailing vehicle or vehicle component by controlling the air flow in the gap between the leading vehicle component and the trailing vehicle component, or by streamlining the airflow around the wheels in the tractor undercarriage and/or in the trailer undercarriage, and by streamlining the rear bumper, as well as by improvements to the rear roll-up door of the trailer.

It is known that the aerodynamic drag for a tractor-trailer truck increases with increasing separation distance between the tractor and the trailer. The air that enters the gap between the tractor and trailer increases the aerodynamic drag, especially with increasing crosswind flow. In the prior art there have been attempts to reduce the aerodynamic drag resulting from flow in the gap region. Prior art teaches both aerodynamic fairings mounted on the tractor cab roof and extensions attached to the side of the tractor cab to close the gap distance between the tractor and the trailer. A reduction in the gap distance will reduce or nearly eliminate gap airflow and thereby reduce aerodynamic drag. Such known gap closure devices, although successful in reducing gap air flow, are typically complex devices that require maintenance and add weight to the vehicle. The increased weight and complexity of the devices has a negative impact on operational performance of the vehicle and interfere with other vehicle systems.

### SUMMARY OF THE INVENTION

The invention relates to airflow that exists in a gap between the base of a leading vehicle and the front face of a trailing vehicle, or to the flow in gaps around wheels of a tractor-trailer, or to airflow around the rear and rear door of a trailing vehicle. Such airflow is a function of the geometry of the vehicle components, the crosswind conditions and the gap dimensions. The invention uses aerodynamic principles to reduce the pressure acting on various surfaces, thereby producing a reduction in aerodynamic drag, improved operational performance and improved stability of multiple component vehicles (tractor-trailers). The invention employs devices for reducing aerodynamic drag utilizing surfaces that are specifically shaped, sized, and oriented to eliminate impingement of air onto the front face or other portions of the trailing vehicle. Some of the surfaces of the fairings are aligned parallel to the vehicle's longitudinal axis which aids in minimizing the aerodynamic drag of both the lead and trailing vehicles.

The invention comprises at least one of several devices for reducing aerodynamic drag for use on a freight tractor or trailer.

A series of retractable window-shade-like devices or roller-mounted screens connect the rear of the tractor with the front of the trailer, above and to each side of the fifth wheel. As the tractor sways and turns, and the trailer articulates, tension in the rollers that hold the retractable screens maintains the screens in the proper orientation, allowing the screens to extend and retract as necessary, while directing most or all of the air passing over the space between the tractor and trailer to pass around the trailer without creating a vortex between the tractor and trailer, and thus increasing the effective mileage for each of gallon of fuel consumed by the tractor.

A fairing is provided on each side of the trailer near the front of the trailer, and which will fit about the rear wheels on the tractor when the tractor and trailer are connected. This fairing extends downwardly from the trailer side, partially between the wheels, and extends further rearward in an arc towards the center of the trailer underside, where it terminates in a point.

A pair of laterally spaced fairings is provided about the fore and aft rearmost pairs of wheels. They are connected to the underside of the trailer, have an aerodynamic rounded forward edge, and they then taper to a rear point.

An aerodynamic rear bumper is provided that has an opening therethrough to allow air to pass, and the bumper has a slight upsweep to direct air passing beneath the trailer to a distant centerpoint behind the trailer.

An upper baffle at the top of the rear roll-up door directs air passing over the top of the trailer to a distant centerpoint behind the trailer.

An aerodynamically improved rearview minor having a wing profile truncated at its rear is provided on each side of the tractor in the view of the operator.

Each of the foregoing features provides a definitively measurable improvement to vehicle operation. Any combination of two or more of these aerodynamic improvements to a tractor-trailer arrangement substantially reduces aerodynamic drag, which concomitantly improves the operational cost of the vehicle.

### OBJECTS OF THE INVENTION

The principal object of the present invention is to provide aerodynamic apparatus for incorporation into a tractor and trailer which reduces drag, increases tractor fuel economy and improves operational performance of a tractor-trailer on which it is installed.

Another object of the invention is to improve the operational efficiency of tractor-trailer vehicles.

Another object of the invention is to improve the fuel efficiency of tractor-trailer vehicles.

Another object of the invention is to provide a means to conserve energy by improving the operational and fuel efficiency of tractor-trailer vehicles.

A further object of the invention is to provide drag-reducing components for tractors and trailers which have minimum maintenance requirements.

### BRIEF DESCRIPTION OF THE DRAWINGS

The foregoing and other objects will become more readily apparent by referring to the following detailed description and the appended drawings in which:

FIG. 1 is an isometric view of a tractor with attached freight trailer showing all aspects of the invention.

FIG. 2 is a partial isometric view of the region between the tractor and trailer.

FIG. 3 is an isometric view of the tractor of FIG. 1 with attached freight trailer, showing the underside of the tractor and trailer.

FIG. 4 is an isometric view of a portion of the bottom of the trailer of FIG. 1 showing the fairings for the rear tractor wheels.

FIG. 5 is an isometric view of a portion of the bottom of the rear of the trailer of FIG. 1 showing the invented fairings for the rear trailer wheels and the rear bumper.

FIG. 6 is a bottom isometric view of a portion of the rear of the trailer of FIG. 1 showing the fairings for the rear trailer wheels, and the rear of the trailer, including an upper baffle, a roll-up door, and the rear bumper.

### DETAILED DESCRIPTION

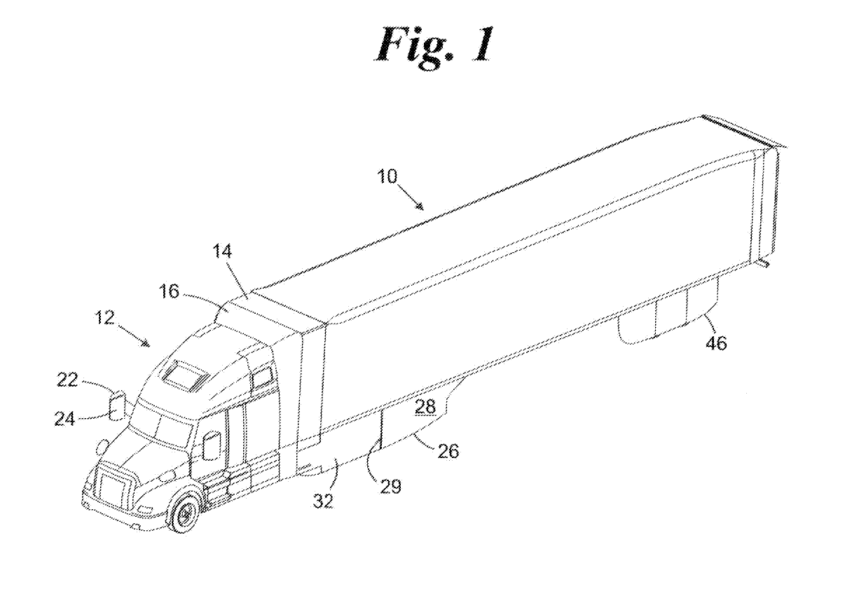

Referring now to the drawings, FIG. 1 shows the relative positions of the various parts of the invention, which in total, includes five separate devices for reducing aerodynamic drag on a freight trailer 10 coupled to a tractor 12.

A series of retractable shade-like devices, which are retractable spring-loaded roller-mounted screens 14, are mounted inside a tractor cowling 16 and connect the rear of the tractor 12 with the front of the trailer 10, above and to each side of the fifth wheel by which the trailer is attached to the tractor. Alternatively, the screen rollers are mounted on the front face 18 of the trailer, and the extended end of the screen is connected to the rear of the tractor. As the tractor sways and turns, and the trailer articulates, tension in the rollers that hold the retractable screens maintains the screens in the proper orientation, allowing the screens to extend and retract as necessary, while directing most or all of the air passing over the space between the tractor and trailer to pass around the screens and the trailer without creating a vortex between the tractor and trailer, and thus increasing the effective mileage for each of gallon of fuel consumed by the tractor.

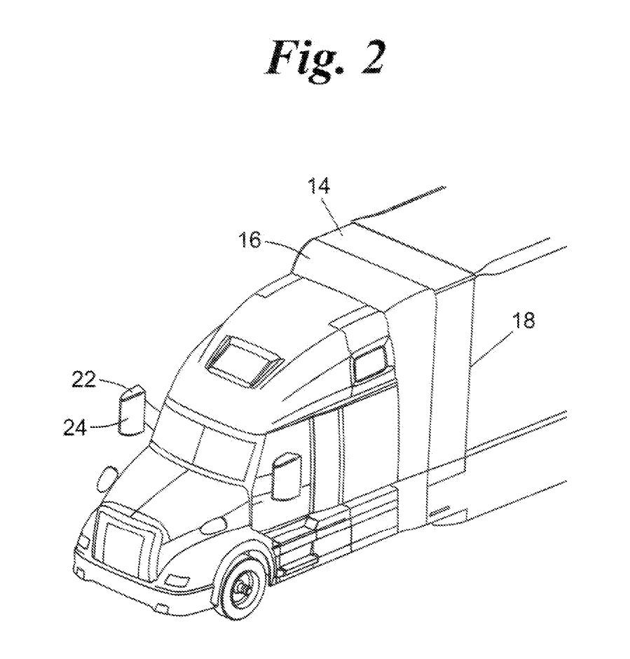

As shown in FIG. 2, rearview mirrors 22 have a wing profile 24 truncated at the front, which improves the mirrors aerodynamically.

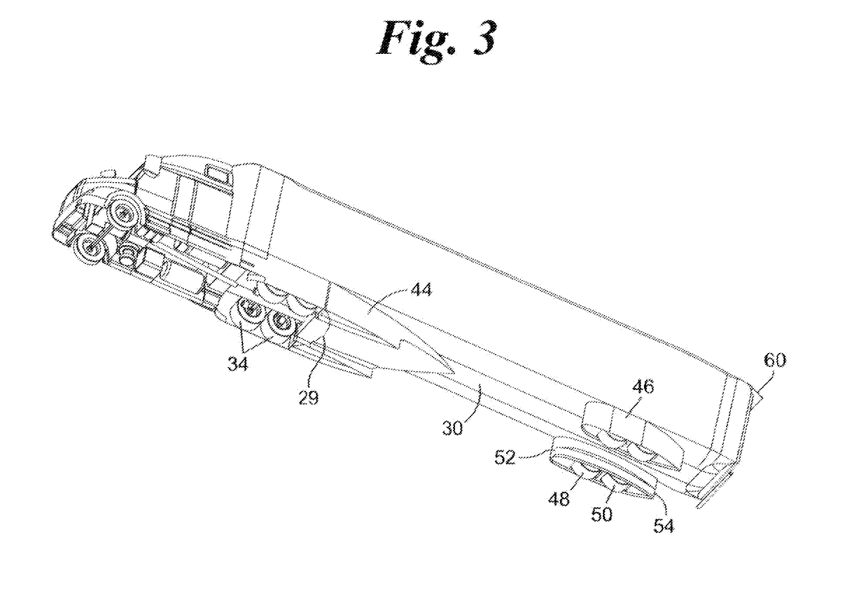

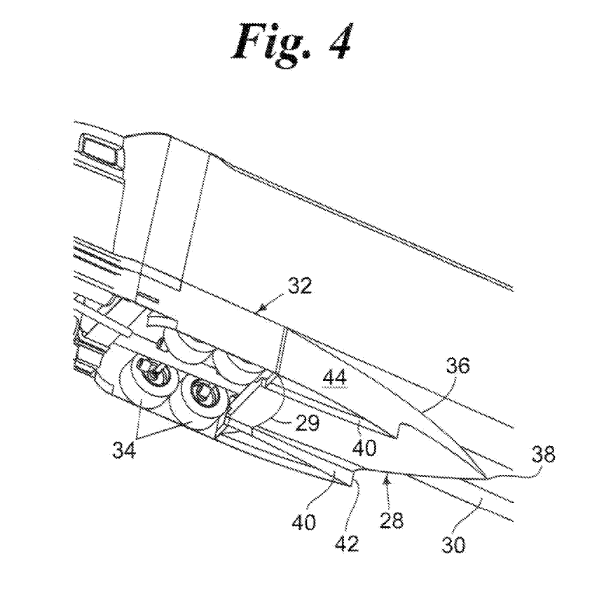

As best shown in FIGS. 3 and 4, a fairing 26 is provided on the underside 30 of the trailer near the front of the trailer, and which will fit about the rear wheels 34 on the tractor when the tractor and trailer are connected. This fairing extends downwardly from the trailer side, partially between the wheels 34, and extends rearward in an arc 36 towards the center of the trailer underside, where it terminates in a point 38. Fairing baffles 40 are incorporated into fairing 26, the baffles 40 themselves being arcuate, as shown, and terminating at a point 42 where the baffles intersect the outer (side) surface 44 of the fairing 26. The fairing 26 consists of a rear portion 28 connected to the underside 30 of the trailer, and a forward portion 32 connected to the tractor. In operation, the portions 28 and 32 of the fairing 26 articulate along dividing line 29.

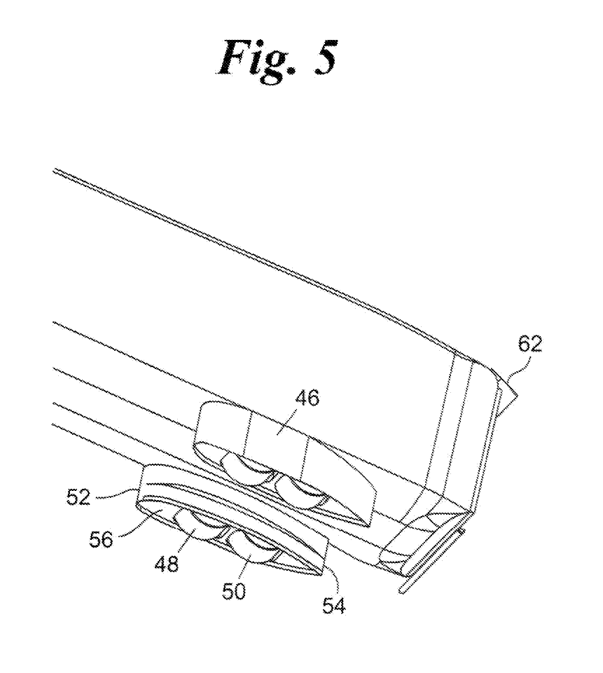

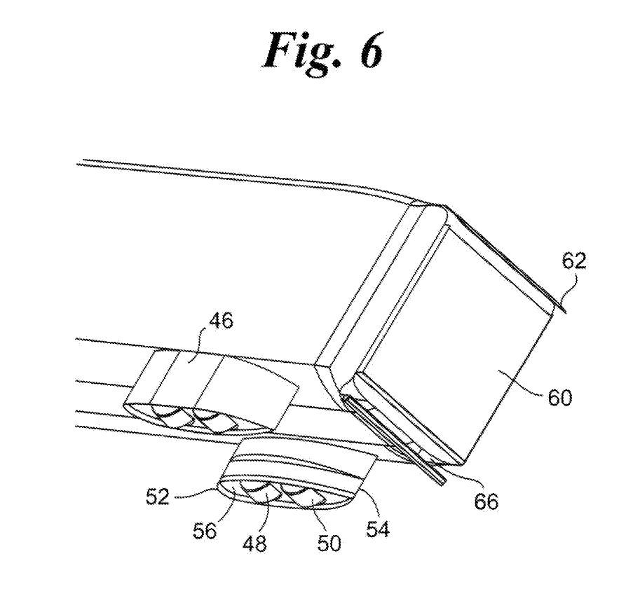

As shown in FIGS. 5 and 6, a pair of laterally spaced rear wheel fairings 46 is provided about the fore 48 and aft 50 wheels of the rearmost pairs of trailer wheels. Fairing 46, which is connected to the underside 30 of the trailer 10, has an aerodynamic rounded forward edge 52 then tapers rearwardly to a rear point 54. A substantial portion of the underside of the fairing 46 is enclosed by plate 56.

An aerodynamic rear bumper arrangement is depicted in FIGS. 5 and 6 which includes an air deflector 66, which may be curved, and which has a slight upsweep or is angularly arranged to direct air passing beneath the trailer to a distant centerpoint to the rear of the trailer.

As shown in FIGS. 5 and 6, the rear of the trailer is provided with a roll-up door 60. An upper baffle 62 is affixed to the trailer at the top of or above the rear roll-up door, from which position it deflects air passing over the top of the trailer to a distant (center-) point behind the trailer where it intersects the air deflected slightly upwardly by the rear air deflector 66. Alternatively, the upper baffle 62 can be incorporated as an integral part of the roll-up rear door 60, the door itself being adapted to roll on the outside of the trailer (as opposed to inside the trailer like all current roll-up doors). In this case, the rear upper baffle would be clear from impeding the loading and unloading of freight, and is not a limiting factor in determining the opening size of the rear door.

In operation, each of the aforementioned devices streamlines the exterior of the tractor and trailer, limiting the air ingress into pockets, thus reducing the pressure loading on the front face of the trailer or on other vehicle components. All of the components which have no moving parts require no maintenance.

### SUMMARY OF THE ACHIEVEMENT OF THE OBJECTS OF THE INVENTION

From the foregoing, it is readily apparent that we have invented apparatus for improving aerodynamics of a freight tractor and trailer, having at least one of the following:

a series of retractable shade-like devices connecting the rear of the tractor with the front of a trailer;

a fairing fixed to the trailer near the front of the trailer, and which is adapted to fit about the rear wheels on the tractor when the tractor and trailer are connected, such fairing extending downwardly from the trailer side, and extending rearwardly in a partial arc towards the rear center of the trailer underside, where it terminates in a point;

a pair of laterally spaced fairings connected to the underside of the trailer about the fore and aft rearmost pairs of wheels, each of said fairings having an aerodynamic rounded forward edge, and a rearward taper to a rear point; and

an upper baffle at the top of a rear roll-up door positioned to direct air passing over the top of the trailer to a distant centerpoint behind the trailer.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

What is claimed is:

1. Apparatus for reducing vehicle drag on a tractor-trailer connected by a fifth wheel, and having a gap between the tractor and the trailer, said apparatus comprising:
a series of retractable roller-mounted, spring-loaded screen devices having a remote screen end remote from the roller, each of said series of screen devices connecting the rear of the tractor with the front of a trailer, above and to each side of the fifth wheel, each roller being mounted on either the tractor or trailer with the screen remote end being connected to the other of the tractor or trailer, such series of screen devices substantially covering the gap between the tractor and the trailer on the sides and the top, whereby, as the vehicle sways and turns, and the trailer articulates, tension in the rollers that hold the retractable screens maintains the screens in the proper orientation, allowing the screens to extend and retract as necessary, while directing most or all of the air passing over the space between the tractor and trailer to pass around the trailer without creating a vortex between the tractor and trailer, and thus increasing the effective mileage for each of gallon of fuel consumed by the tractor.

2. Apparatus for improving aerodynamics of a freight trailer, comprising:
a fairing fixed to the underside of the trailer near the front of the trailer, and having outer baffles adapted to fit about the rear wheels on the tractor when the tractor and trailer are connected, such fairing extending downwardly from the trailer side, partially between the tractor wheels, and extending rearward in an arc towards the rear center of the trailer underside, where it terminates in a point.

3. Apparatus according to claim 2, wherein said fairing has a fore portion affixed to said tractor, and a rear portion affixed to said trailer, said rear portion being movable in an arc about the center of a fifth wheel by which said trailer is attached to said tractor.

4. Apparatus for improving aerodynamics of a freight trailer, comprising a pair of laterally spaced fairings connected to the underside of the trailer about the rearmost wheels, each of said fairings having an aerodynamic rounded forward edge, and a rearward taper to a rear point.

5. Apparatus according to claim 4, wherein said trailer is provided with pairs of fore and aft wheels, each of fairings being positioned about a pair of said fore and aft wheels.

6. Apparatus according to claim 1, further comprising an upper baffle at the top of a rear roll-up door positioned to direct air passing over the top of the trailer to a distant centerpoint behind the trailer.

7. Apparatus according to claim 6, further comprising an air deflector positioned at the bottom rear of the trailer, and having a slight upsweep to direct air passing beneath the trailer to a distant centerpoint to the rear of the trailer.

8. Apparatus according to claim 1, further comprising an aerodynamically improved rearview mirror having a wing profile truncated at the forward facing end.
